(19) United States
(12) Patent Application Publication
(10) Pub. No.: US 2026/0336039 A1
(43) Pub. Date: Oct. 29, 2026

(54) SOLID WIRE AND GAS SHIELDED ARC WELDING METHOD

(71) Applicant: Kabushiki Kaisha Kobe Seiko Sho (Kobe Steel, Ltd.), Kobe-shi (JP)

(72) Inventors: Shinya ISONO, Kanagawa (JP); Hideaki TAKAUCHI, Kanagawa (JP)

(73) Assignee: Kabushiki Kaisha Kobe Seiko Sho (Kobe Steel, Ltd.), Kobe-shi (JP)

(21) Appl. No.: 19/124,401

(22) PCT Filed: Oct. 4, 2023
(86) PCT No.: PCT/JP2023/036286

§ 371 Date: Apr. 25, 2025

(30) Foreign Application Priority Data
Nov. 2, 2022 (JP) 2022-176386

(51) Int. Cl. B23K 35/30; B23K 9/16; B23K 35/02; C22C 38/00; C22C 38/02; C22C 38/04; C22C 38/06; C22C 38/42; C22C 38/44; C22C 38/46; C22C 38/48; C22C 38/50; C22C 38/52

(52) U.S. Cl. CPC B23K 35/3086; B23K 9/16; B23K 35/0261; C22C 38/001; C22C 38/002; C22C 38/02; C22C 38/04; C22C 38/06; C22C 38/42; C22C 38/44; C22C 38/46; C22C 38/48; C22C 38/50; C22C 38/52

(57) ABSTRACT

To provide a solid wire capable of obtaining back beads with excellent appearance and a weld metal with excellent mechanical performance without using a backing gas. A solid wire for welding a steel material containing 1 mass % or more and 10 mass % or less of Cr, the solid wire containing, in terms of mass % based on a total mass of the wire:
C: 0.05% or more and 0.15% or less;
Si: 0.8% or more and 1.7% or less;
Mn: 0.4% or more and 1.2% or less;
Cr: 7.5% or more and 13.0% or less;
Mo: 0.70% or more and 1.5% or less;
Nb: 0.010% or more and 0.10% or less;
V: 0.10% or more and 0.50% or less;
N: 0.010% or more and 0.070% or less;
P: 0.030% or less;
S: 0.030% or less;
Ni: 0.80% or less;
Ti: 0.025% or less;
Al: 0.020% or less; and
Co: 0.70% or less,
with the remainder being Fe and unavoidable impurities.

### TECHNICAL FIELD

The present invention relates to a solid wire and a gas shielded arc welding method.

### BACKGROUND ART

In general, a steel material in which Nb, V, and the like are added to 9Cr-1Mo steel containing 8 mass % to 10 mass % of Cr and 0.85 mass % to 1.20 mass % of Mo is called 9Cr-1Mo-Nb—V steel. Such Cr—Mo ferritic high strength heat resistant steels, typified by 9Cr-1Mo-Nb—V steel, have excellent high temperature properties and are used in boilers and pressure vessels for thermal power generation and nuclear power generation.

When gas shielded arc welding is performed on the above-mentioned steel materials with a high content of Cr as single welded butt joints, in order to prevent poor appearance of beads generated by back bead welding due to formation of Cr oxides with a high melting point on a back bead surface, back shielding with an inert gas is required for the first layer of welding. However, continuously flowing a backing gas from a back side of a steel material increases a cost and makes the work complicated when the target steel material is, for example, a pipe material.

Patent Literature 1 discloses a welding material that can produce welds having excellent back bead performance and mechanical performance without using a backing gas. In the welding material described in Patent Literature 1, contents of C, Cr, Mo, Ni and Al are specified, and a relation between the contents of Cr and Mn and a content of Si, a relation between a content of S and a content of Mn, and a total amount of the content of Al and a content of O are controlled, and the contents of P and S in impurities are specified.

### CITATION LIST

### Patent Literature

Patent Literature 1: JPH10-24388A

### SUMMARY OF INVENTION

### Technical Problem

A weld metal for a ferritic high strength heat resistant steel such as the 9Cr-1Mo-Nb—V steel may be subjected to a post weld heat treatment (PWHT) for a purpose of improving toughness and the like. However, in the welding material described in Patent Literature 1, a high temperature transformation temperature (Ac1 transformation point) has not been considered, and depending on a temperature of the PWHT, the toughness of the weld metal may not be ensured. There is also room for further improvement in the back bead performance and the mechanical performance of the first layer.

Furthermore, in Patent Literature 1, prevention of formation of δ-ferrite is not sufficiently considered. In order to form a weld metal that is adequate for use in boilers and pressure vessels for thermal power generation and nuclear power generation, it is important to further prevent the formation of δ-ferrite.

The present invention has been made in view of the above-mentioned problems, and an object thereof is to provide a solid wire and a gas shielded arc welding method that can be used for welding a steel material containing 1 mass % or more and 10 mass % or less of Cr, and that can obtain back beads with excellent appearance and a weld metal with excellent mechanical performance without using a backing gas.

### Solution to Problem

As a result of diligent research to solve the above problems, the present inventors have found that in order to prevent occurrence of poor formation of back beads, it is particularly important to control a content of Si in a solid wire. The present inventors have also found that by controlling contents of Nb, V and Co in the solid wire, it is possible to prevent the formation of δ-ferrite and obtain a weld metal having desired mechanical properties. The present invention was made based on these findings.

The above object of the present invention is achieved by the following configuration (1) of the solid wire.
(1) A solid wire for welding a steel material containing 1 mass % or more and 10 mass % or less of Cr, the solid wire containing, based on a total mass of the wire:
C: 0.05 mass % or more and 0.15 mass % or less;
Si: 0.8 mass % or more and 1.7 mass % or less;
Mn: 0.4 mass % or more and 1.2 mass % or less;
Cr: 7.5 mass % or more and 13.0 mass % or less;
Mo: 0.70 mass % or more and 1.5 mass % or less;
Nb: 0.010 mass % or more and 0.10 mass % or less;
V: 0.10 mass % or more and 0.50 mass % or less;
N: 0.010 mass % or more and 0.070 mass % or less;
P: 0.030 mass % or less;
S: 0.030 mass % or less;
Ni: 0.80 mass % or less;
Ti: 0.025 mass % or less;
Al: 0.020 mass % or less; and
Co: 0.70 mass % or less,
with the remainder being Fe and unavoidable impurities.

A preferred embodiment of the solid wire according to the present invention relates to the following (2) and (3).
(2) The solid wire according to (1), further containing, based on the total mass of the wire:
Zr: 0.10 mass % or less.
(3) The solid wire according to (1) or (2), further containing, based on the total mass of the wire:
Cu: 0.50 mass % or less.

The above object of the present invention is achieved by the following configuration (4) according to a gas shielded arc welding method.
(4) A gas shielded arc welding method including:
welding a steel material containing 1 mass % or more and 10 mass % or less of Cr, with the solid wire according to any one of (1) to (3), without using a backing gas.

### Advantageous Effects of Invention

The present invention can provide a solid wire capable of obtaining back beads with excellent appearance and a weld metal with excellent mechanical performance without using a backing gas, and a gas shielded arc welding method using the solid wire.

### DESCRIPTION OF EMBODIMENTS

Hereinafter, an embodiment of the present invention will be described in detail. Note that in the present specification, a solid wire may be simply referred to as a “wire”. The present invention is not limited to the embodiment described below, and can be optionally modified and implemented without departing from the gist of the present invention.

### [Solid Wire]

A solid wire according to the present embodiment is used for welding a steel material containing 1 mass % or more and 10 mass % or less of Cr. For example, steel materials to be welded can be made up of a combination of 9% Cr steel and 2% Cr steel, and the solid wire according to the present embodiment can also be applied to a dissimilar joint. The solid wire according to the present embodiment is particularly preferably used for welding 9Cr-1Mo-Nb—V steel.

Hereinafter, a steel having a content of Cr of 8 mass % or more and 10 mass % or less may be referred to as the 9% Cr steel. In the present embodiment, a shape of the steel material used as the steel material to be welded is not particularly limited, and the present invention can be applied to welding, for example, steel plates, steel pipes, and the like.

Chemical components contained in the solid wire according to the present embodiment will be described in detail below with respect to reasons for containing and reasons for limiting numerical values thereof.

### <C: 0.05 Mass % or More and 0.15 Mass % or Less>

C is an important element that combines with Cr, Mo, V, and Nb to form carbides and has an effect of ensuring strength of a weld metal. Furthermore, as an austenite forming element, C contributes to preventing formation of δ-ferrite in the weld metal. If a content of C is less than 0.05 mass % based on a total mass of the wire, desired strength of the weld metal cannot be obtained. Therefore, the content of C based on the total mass of the wire is 0.05 mass % or more, preferably 0.06 mass % or more, and more preferably 0.07 mass % or more.

On the other hand, if the content of C based on the total mass of the wire exceeds 0.15 mass %, a solidification temperature of a segregation portion is greatly lowered, and hot cracks are likely to occur. In addition, carbides precipitation becomes excessive, reducing toughness of the weld metal. Therefore, the content of C based on the total mass of the wire is 0.15 mass % or less, preferably 0.14 mass % or less, and more preferably 0.13 mass % or less.

### <Si: 0.8 Mass % or More and 1.7 Mass % or Less>

Si preferentially forms an oxide film on a back bead surface, which has a low melting point and is unlikely to inhibit solidification of the weld metal, and has an effect of preventing poor formation of back beads due to oxidation of Cr during welding. If a content of Si based on the total mass of the wire is less than 0.8 mass %, the above-mentioned effects cannot be sufficiently obtained, and a back bead shape deteriorates. Therefore, the content of Si based on the total mass of the wire is 0.8 mass % or more, preferably 0.9 mass % or more, and more preferably 1.0 mass % or more.

On the other hand, if the content of Si exceeds 1.7 mass % based on the total mass of the wire, an excessive amount of δ-ferrite is formed in the weld metal, and the toughness of the weld metal decreases. In addition, an amount of slag generated on surface beads increases, making slag inclusion more likely to occur. Therefore, the content of Si based on the total mass of the wire is 1.7 mass % or less, preferably 1.6 mass % or less, and more preferably 1.5 mass % or less.

### <Mn: 0.4 Mass % or More and 1.2 Mass % or Less>

Mn is an element that functions as a deoxidizing agent for the weld metal and has an effect of improving the strength and toughness of the weld metal. Furthermore, as an austenite forming element, Mn contributes to preventing formation of the δ-ferrite in the weld metal. If a content of Mn based on the total mass of the wire is less than 0.4 mass %, insufficient deoxidation is caused and the effect of reducing residual δ-ferrite in the weld metal cannot be sufficiently obtained, resulting in a decrease in the toughness of the weld metal. Therefore, the content of Mn based on the total mass of the wire is 0.4 mass % or more, preferably 0.5 mass % or more, and more preferably 0.6 mass % or more.

On the other hand, if the content of Mn based on the total mass of the wire exceeds 1.2 mass %, high-temperature strength of the weld metal deteriorates. The solidification temperature of the segregation portion is also lowered, and a transformation point is also lowered, which makes it difficult to perform PWHT at a high temperature. Furthermore, Mn generates a complex oxide with Cr, causing poor formation of the back beads. Therefore, the content of Mn based on the total mass of the wire is 1.2 mass % or less, preferably 1.1 mass % or less, and more preferably 1.0 mass % or less.

### <Cr: 7.5 Mass % or More and 13.0 Mass % or Less>

In welding using the solid wire according to the present embodiment, Cr is a major element a steel material to be welded with a high content of Cr, which is difficult to form a good back bead, and is an essential element for ensuring oxidation resistance at a high temperature and high-temperature strength of the weld metal. If a content of Cr based on the total mass of the wire is less than 7.5 mass %, the oxidation resistance and high-temperature strength of the weld metal become insufficient. Therefore, the content of Cr based on the total mass of the wire is 7.5 mass % or more, preferably 7.8 mass % or more, and more preferably 8.0 mass % or more.

On the other hand, if the content of Cr exceeds 13.0 mass % based on the total mass of the wire, even if the content of Si is controlled as described above, an oxide film that inhibits uniform solidification of the weld metal with a high melting point is formed on the back bead surface. In addition, Cr is a ferrite generation element and thus causes δ-ferrite to remain, deteriorating the toughness and creep performance of the weld metal. Therefore, the Cr content based on the total mass of the wire is 13.0 mass % or less, preferably 12.5 mass % or less, and more preferably 12.0 mass % or less.

### <Mo: 0.70 Mass % or More and 1.5 Mass % or Less>

Mo is a solid-solution hardening element and is also an element having an effect of improving the high-temperature strength by precipitating carbides. If a content of Mo based on the total mass of the wire is less than 0.70 mass %, the high-temperature strength of the weld metal becomes insufficient. Therefore, the content of Mo based on the total mass of the wire is 0.70 mass % or more, preferably 0.75 mass % or more, and more preferably 0.80 mass % or more.

On the other hand, if the content of Mo exceeds 1.5 mass % based on the total mass of the wire, the δ-ferrite will remain, and the toughness and creep performance of the weld metal deteriorate. Therefore, the content of Mo based on the total mass of the wire is 1.5 mass % or less, preferably 1.3 mass % or less, and more preferably 1.2 mass % or less.

### <Nb: 0.010 Mass % or More and 0.10 Mass % or Less>

Nb is an element that has an effect of improving the strength of the weld metal by solid-solution hardening and precipitating as nitrides. If a content of Nb based on the total mass of the wire is less than 0.010 mass %, the effect of improving the strength of the weld metal cannot be sufficiently obtained. Therefore, the content of Nb based on the total mass of the wire is 0.010 mass % or more, preferably 0.013 mass % or more, and more preferably 0.015 mass % or more.

On the other hand, if the content of Nb based on the total mass of the wire exceeds 0.10 mass %, the δ-ferrite will remain and the toughness of the weld metal will be significantly deteriorated. Therefore, the content of Nb based on the total mass of the wire is 0.10 mass % or less, preferably 0.09 mass % or less, and more preferably 0.08 mass % or less.

### <V: 0.10 Mass % or More and 0.50 Mass % or Less>

V is an element that precipitates in the weld metal as carbonitrides and has an effect of improving the strength of the weld metal. If a content of V based on the total mass of the wire is less than 0.10 mass %, the effect of improving the strength of the weld metal cannot be sufficiently obtained. Therefore, the content of V based on the total mass of the wire is 0.10 mass % or more, preferably 0.13 mass % or more, and more preferably 0.15 mass % or more.

On the other hand, if the content of V based on the total mass of the wire exceeds 0.50 mass %, the δ-ferrite will remain and the toughness of the weld metal will be deteriorated. Therefore, the content of V based on the total mass of the wire is 0.50 mass % or less, preferably 0.40 mass % or less, and more preferably 0.30 mass % or less.

### <N: 0.010 Mass % or More and 0.070 Mass % or Less>

N is an element that contributes to solid-solution hardening and stabilization of strength by precipitating as nitrides. N is also an austenite forming element, and is an element that has an effect of reducing the δ-ferrite in the weld metal. If a content of N based on the total mass of the wire is less than 0.010 mass %, the above-mentioned effects cannot be sufficiently obtained, the strength will deteriorate, and the δ-ferrite will be generated. Therefore, the content of N based on the total mass of the wire is 0.010 mass % or more, preferably 0.015 mass % or more, and more preferably 0.020 mass % or more.

On the other hand, if the content of N based on the total mass of the wire exceeds 0.070 mass %, blowholes are generated. Therefore, the content of N based on the total mass of the wire is 0.070 mass % or less, preferably 0.065 mass % or less, and more preferably 0.060 mass % or less.

### <P: 0.030 Mass % or Less>

P is an impurity element and is a component that increases hot cracking susceptibility. If a content of P based on the total mass of the wire exceeds 0.030 mass %, there is a concern that hot cracks may occur. Therefore, the content of P based on the total mass of the wire is set to 0.030 mass % or less, preferably 0.020 mass % or less, and more preferably 0.015 mass % or less.

### <S: 0.030 Mass % or Less>

S has an effect of affecting convection in a molten pool, increasing a penetration depth, improving arc stability, and forming good back beads. In the present embodiment, a lower limit of a content of S is not particularly limited and may be 0 mass %, but when S is contained in the wire for the purpose of further improving the back bead forming ability, the content of S based on the total mass of the wire is preferably 0.003 mass % or more, and more preferably 0.005 mass % or more.

On the other hand, if the content of S exceeds 0.030 mass % based on the total mass of the wire, there is a concern that hot cracks may occur. Therefore, the content of S based on the total mass of the wire is 0.030 mass % or less, preferably 0.025 mass % or less, and more preferably 0.020 mass % or less.

### <Ni: 0.80 Mass % or Less>

Ni, as Mn, is an austenite forming element and contributes to preventing formation of the δ-ferrite in the weld metal. In the present embodiment, a lower limit of a content of Ni is not particularly limited and may be 0 mass %, but when Ni is contained in the wire for the purpose of preventing the formation of the δ-ferrite in the weld metal, the content of Ni based on the total mass of the wire is preferably 0.05 mass % or more, and more preferably 0.10 mass % or more.

On the other hand, if the content of Ni exceeds 0.80 mass % based on the total mass of the wire, the high-temperature strength of the weld metal deteriorates. The transformation point is also lowered, making PWHT at a high temperature difficult. Therefore, the content of Ni based on the total mass of the wire is 0.80 mass % or less, preferably 0.60 mass % or less, and more preferably 0.50 mass % or less.

### <Ti: 0.025 Mass % or Less>

Ti forms an oxide film that inhibits uniform solidification of the weld metal and deteriorates the formation of a good back bead shape. If a content of Ti exceeds 0.025 mass % based on the total mass of the wire, the back bead shape deteriorates. Therefore, the content of Ti based on the total mass of the wire is 0.025 mass % or less, preferably 0.018 mass % or less, and more preferably 0.015 mass % or less.

### <Al: 0.020 Mass % or Less>

Al, as Si, is an element that preferentially forms an oxide film on the back bead surface, which has a low melting point and is unlikely to inhibit the solidification of the weld metal, but since Al has a high slag generating ability, there is a concern that Al may cause slag inclusion. Al is also a ferrite forming element, and excessive δ-ferrite may be formed in the weld metal, reducing the toughness of the weld metal. Furthermore, Al forms nitrides preferentially over Nb and V, and therefore inhibits the formation of Nb and V nitrides which have an effect of ensuring the high-temperature strength, resulting in a decrease in high-temperature strength. Therefore, the content of Al based on the total mass of the wire is 0.020 mass % or less, preferably 0.015 mass % or less, and more preferably 0.012 mass % or less.

### <Co: 0.70 Mass % or Less>

Co, as Ni and Mn, is an austenite forming element, and is an element that contributes to preventing the formation of the δ-ferrite in the weld metal, and by containing Co in the wire, it is possible to obtain desired mechanical performance of the weld metal. In the present embodiment, a lower limit of a content of Co is not particularly limited and may be 0 mass %, but when Co is contained in the wire for the purpose of preventing the formation of δ-ferrite in the weld metal, the content of Co based on the total mass of the wire is preferably 0.005 mass %, more preferably 0.05 mass % or more, still more preferably 0.10 mass % or more, and particularly preferably 0.15 mass % or more.

On the other hand, if the content of Co based on the total mass of the wire exceeds 0.70 mass %, the transformation point is lowered and PWHT at a high temperature becomes difficult. Therefore, the content of Co based on the total mass of the wire is 0.70 mass % or less, preferably 0.60 mass % or less, and more preferably 0.50 mass % or less.

In addition to the above components, the solid wire according to the present embodiment may contain either or both of Zr and Cu within ranges shown below. Contents of components that the wire may further contain and reasons for limiting the contents thereof will be described below.

### <Zr: 0.10 Mass % or Less>

Zr, as Si, is an element that preferentially forms an oxide film on the back bead surface, which is unlikely to inhibit the solidification of the weld metal, and therefore, it is preferable to contain Zr in the solid wire according to the present embodiment as necessary. If a content of Zr in the wire is in a range of 0.10 mass % or less, poor formation of the back beads due to oxidation of Cr during welding can be prevented without reducing the toughness due to excessive generation of δ-ferrite. Therefore, if Zr is contained in the solid wire according to the present embodiment, the content of Zr based on the total mass of the wire is preferably 0.10 mass % or less, preferably 0.08 mass % or less, and more preferably 0.07 mass % or less.

On the other hand, when Zr is contained in the wire for obtaining the above-mentioned effect, the content of Zr based on the total mass of the wire is preferably 0.005 mass % or more, and more preferably 0.010 mass % or more.

### <Cu: 0.50 Mass % or Less>

Cu, as Ni and Mn, is an austenite forming element, and is an element that contributes to preventing the formation of δ-ferrite in the weld metal, and therefore, it is preferable for the solid wire according to the present embodiment to contain Cu as necessary. When the wire contains Cu in a range of 0.50 mass % or less, it is possible to obtain a weld metal having desired mechanical performance without deteriorating the high-temperature strength of the weld metal. Therefore, when Cu is contained in the solid wire according to the present embodiment, a content of Cu based on the total mass of the wire is preferably 0.50 mass % or less, more preferably 0.40 mass % or less, and still more preferably 0.30 mass % or less.

On the other hand, when Cu is contained in the wire for obtaining the above-mentioned effect, the content of Cu based on the total mass of the wire is preferably 0.01 mass % or more, more preferably 0.05 mass % or more, and still more preferably 0.10 mass % or more. Note that the wire of the present embodiment may be plated with Cu, and the content of Cu includes an amount of copper plating.

### <Remainder: Fe and Unavoidable Impurities>

The remainder of the solid wire according to the present embodiment is Fe and unavoidable impurities. The unavoidable impurities refer to those that are not intentionally added to the wire, and examples of elements other than those mentioned above include B, Sn, As, and Sb. A total content of the impurities in the solid wire is preferably 0.10 mass % or less, and more preferably 0.05 mass % or less.

### [Gas Shielded Arc Welding Method]

The gas shielded arc welding method according to the present embodiment is a welding method for welding a steel material to be welded having a content of Cr of 1 mass % or more and 10 mass % or less, using the above-mentioned solid wire without using a backing gas. As described above, when a solid wire in the related art is used for welding a steel material to be welded with a content of Cr of, for example, 8 mass % to 10 mass %, the back beads are easily oxidized, and the shape and appearance of the back beads deteriorate. However, by using the solid wire according to the present embodiment for at least the first layer of welding, back beads having excellent back bead performance and mechanical performance can be formed without using a backing gas, not only for steel materials with a high content of Cr, which is particularly susceptible to back bead oxidation, but also for steel materials to be welded having a content of Cr of 1 mass % or more and 10 mass % or less.

Note that in the gas shielded arc welding method according to the present embodiment, the type of welding is not particularly limited, and in addition to tungsten inert gas (TIG) welding, metal active gas (MAG) welding and metal inert gas (MIG) welding can be used.

### <Type and Flow Rate of Shielding Gas>

When welding with the solid wire according to the present embodiment, a shielding gas used on a front side is not particularly limited, and for example, Ar gas, carbon dioxide gas, a mixed gas of Ar gas and carbon dioxide gas, or a mixed gas of Ar gas and oxygen gas can be used. A flow rate of the gas is not particularly limited, and may be, for example, 15 L/min to 50 L/min.

### <Welding Position, Wire Diameter>

A welding position when using the solid wire according to the present embodiment is not particularly limited, and welding can be performed in various welding positions. Furthermore, a wire diameter (diameter) of the solid wire according to the present embodiment is not particularly limited, and can be applied to wires having diameters specified in welding material standards in AWS, JIS, or the like.

### EXAMPLES

Hereinafter, effects of the present invention will be specifically described with reference to inventive examples and comparative examples according to the present invention, but the present invention is not limited thereto.

### [Production of Solid Wire]

Solid wires were prepared so that the components contained in the wires had various contents. The contents (mass %) of the chemical components per total mass of the wire are shown in Table 1 below. Note that the remainder of the wires, excluding the chemical components shown in Table 1 below, is Fe and unavoidable impurities.

### [Gas Shielded Arc Welding (for Back Bead Evaluation)]

Welding was carried out for back bead evaluation. Specifically, a pair of steel plates having a plate thickness of 19 mm, a steel type of ASTM A387 Grade 91 Class 2, and a groove angle of 70° was prepared, and the first layer was formed by TIG welding. Welding conditions are as follows.

### <Welding Conditions>

Welding method: TIG welding
Wire diameter: 2.4 mm
Root gap: 2 mm to 3 mm
Welding current: 90 A to 110 A
Arc voltage: 10 V to 14 V
Preheat: 150 °C to 300 °C
Shielding gas type and flow rate: 100% Ar, 15 L/min
Backing gas: None
Welding position: flat

### [Back Bead Evaluation Test]

### <Evaluation Items>

For the weld metal obtained using each solid wire, a back side of welding (back bead appearance) was visually observed, and cross-sectional macrograph of the weld metal was visually observed to evaluate the back beads. With respect to the appearance of the back beads, the degree of oxidation, the presence or absence of burn-through, and the presence or absence of concave beads were observed. With respect to the cross-sectional macrograph observation, the height of the back beads, the depth of depression in the back beads, and the shape of a boundary between the base metal and the back beads were observed. The measurement results and evaluation results for each evaluation item are shown in Table 2 below.

### <Evaluation Method and Evaluation Criteria>

### (Back Bead Appearance)

For the back bead appearance, the back beads having a uniform width, free of meandering or unevenness, having no discoloration or unevenness due to oxidation, and having no burn-through or concave beads were judged as being good. On the other hand, the back beads having uneven widths and a lot of unevenness, discolored or being uneven due to oxidation, or with burn-through or concave beads were to be judged as fail, and for those judged to fail, a state of the appearance thereof was recorded in the measurement result column.

### (Back Bead Height)

In the cross-sectional macrograph, a height of the back bead was measured. In the present example, the back bead with a height of 0.5 mm or more was judged to pass, the back bead with a height less than 0.5 mm was judged to fail, and the height of the back bead was recorded in the measurement result column.

### (Depression Depth)

The presence or absence of depressions near ends of the back bead in the width direction was observed, and if there was a depression, a depth of the depression was measured. In the present example, a test piece that does not have a depression with a depth of 0.5 mm or more on a back side of the base metal was judged to pass, and a test piece having a depression with a depth of 0.5 mm or more was judged to fail, and the depth of the depression was recorded in the measurement result column.

(Shape of Boundary between Base Metal and Back Beads)

The shape of the boundary between the base metal and the back beads was observed in the cross-sectional macrograph, and a test piece that had a gentle convex shape from the base metal to the back beads was judged as being good (pass), and a test piece in which the back beads rise sharply at the boundary between the base metal and the back beads was judged as being bad (fail), and “good” or “bad” was recorded in the measurement result column. Note that in cases where burn-through occurs, the back beads tend to rise sharply and form a convex shape at the boundary between the base metal and the back beads.

### (Overall Evaluation of Back Bead)

In the back bead evaluation, a test piece that passes all of the above items was given a grade of “A”, and a test piece that fails one or more items was given a grade of “C”, and the evaluation result was recorded in the measurement result column for the back beads.

### [Gas Shielded Arc Welding (for Weld Metal Evaluation)]

Welding was performed for weld metal evaluation. Specifically, a groove angle of SM490A steel materials described in JIS G3106:2020 and having a plate thickness of 12 mm were processed to 45°, and the inside of the groove and a backing metal were buttered in two or more layers using the produced solid wire, and then the weld metal was formed by multi-layer welding using TIG welding with a root spacing of 6.5 mm. Welding conditions are as follows.

### <Welding Conditions>

Welding method: TIG welding
Wire diameter: 1.2 mm
Welding current: 160 A to 180 A
Arc voltage: 10 V to 16 V
Shielding gas type and flow rate: 100% Ar, 25 L/min
Welding position: flat
PWHT temperature and time: 760 °C, 2 hour

### [Mechanical Performance Evaluation Test of Weld Metal]

### <Evaluation Items>

For the weld metals obtained using each solid wire, the Ac1 transformation point was measured to evaluate a tolerance of PWHT temperature setting, and an area ratio of δ-ferrite was also measured. The mechanical performance was evaluated by conducting a tensile test and the Charpy impact test. The measurement results and evaluation results for each evaluation item are shown together in Table 2 below. Note that on some of the test pieces with bad back beads, the mechanical performance evaluation test of the weld metal was not performed.

### <Evaluation Method and Evaluation Criteria>

### (Measurement of Ac1 Transformation Point)

A round bar-shaped test piece having a diameter of 8 mm and a length of 12 mm was taken from the obtained weld metal before PWHT, and the Ac1 transformation point was measured by measuring a volume change of the test piece during heating by high-frequency induction heating.

Note that when PWHT is performed at a temperature higher than the Ac1 transformation point, the weld metal undergoes reverse transformation to form a structure containing fresh martensite, which has high strength and low toughness, and the performance of the weld joint deteriorates. Therefore, a higher Ac1 transformation point allows for a larger tolerance in the temperature setting for PWHT. Therefore, as evaluation criteria, those with an Ac1 transformation point of 800 °C or higher were rated as “A” (excellent); those with an Ac1 transformation point of 780 °C or higher and less than 800 °C were rated as “B” (good); and those with an Ac1 transformation point of less than 780 °C were rated as “C” (bad).

### (Measurement of δ-Ferrite Area Ratio)

From the obtained weld metal before PWHT, a 12 mm square test piece including a final pass as-cast zone of a cross section perpendicular to the welding direction was taken, and a microstructure of the final pass as-cast zone was observed after appropriate polishing and etching, and the area ratio of δ-ferrite was measured in a field of view with a magnification of 100. The area ratio was measured using a point counting method, and the area ratio was calculated from 600 or more grid points per field of view.

Note that δ-ferrite is what remains without being transformed into austenite during welding, and has an adverse effect on strength and toughness, deteriorating weld joint performance, and therefore a small area ratio is good. Therefore, as evaluation criteria, those with an area ratio of δ-ferrite of less than 5% were rated as “A” (excellent); those with an area ratio of 5% or more and less than 10% were rated as “B” (good); and those with an area ratio of 10% or more were rated as “C” (bad).

### (Tensile Test)

A tensile test piece having a diameter of 6 mm and a gauge length of 24 mm was taken from a center in a plate thickness direction of the obtained weld metal parallel to a welding direction, and a room temperature tensile strength (TS) of the weld metal was measured in accordance with a tensile testing method for metallic materials described in JIS Z 2241:2011.

Note that as the evaluation criteria, a tensile test measurement result of 720 MPa or more was rated as “A” (excellent), a result of 620 MPa or more and less than 720 MPa was rated as “B” (good), and a result of less than 620 MPa was rated as “C” (bad).

### (Charpy Impact Test)

2 mm V-notch Charpy impact test pieces were taken perpendicular to the welding direction from the center in the plate thickness direction of the obtained weld metal, and the Charpy impact value at 20 °C was measured in accordance with the Charpy impact test method for metallic materials described in JIS Z 2242:2005.

Note that as the evaluation criteria for toughness based on the Charpy impact value, the Charpy impact value, which is obtained by dividing an absorbed energy measurement result measured in the Charpy impact test at 20 °C by an original cross-sectional area of a notch, of 60 (J/cm²) or more was rated as “A” (excellent), and the Charpy impact value of 34 (J/cm²) or more and less than 60 (J/cm²) was rated as “B” (good), and the Charpy impact value of less than 34 (J/cm²) was rated as “C” (bad).

TABLE 1

| No. | | C | Si | Mn | Cr | Mo | Nb | V | N | P | S | Ni | Ti | Al | Co | Zr | Cu |
|---|---|---|---|---|---|---|---|---|---|---|---|---|---|---|---|---|---|
| Inventive | A1 | 0.14 | 0.92 | 0.78 | 9.01 | 1.01 | 0.028 | 0.20 | 0.033 | <0.003 | 0.006 | 0.13 | 0.003 | 0.002 | 0.40 | <0.005 | 0.01 |
| Example | A2 | 0.10 | 1.17 | 0.67 | 8.85 | 0.97 | 0.023 | 0.20 | 0.054 | <0.003 | 0.006 | 0.20 | <0.002 | 0.003 | 0.40 | <0.005 | <0.01 |
| | A3 | 0.10 | 1.49 | 0.68 | 8.75 | 0.95 | 0.023 | 0.21 | 0.053 | <0.003 | 0.007 | 0.20 | <0.002 | 0.005 | 0.40 | <0.005 | <0.01 |
| | A4 | 0.10 | 0.87 | 0.85 | 9.00 | 0.96 | 0.024 | 0.20 | 0.060 | <0.003 | 0.006 | 0.18 | <0.002 | 0.007 | 0.34 | 0.043 | <0.01 |
| | A5 | 0.12 | 1.25 | 0.65 | 8.50 | 0.96 | 0.023 | 0.20 | 0.054 | <0.003 | 0.007 | 0.18 | <0.002 | 0.007 | 0.34 | 0.025 | <0.01 |
| | A6 | 0.10 | 1.46 | 0.67 | 8.80 | 0.95 | 0.023 | 0.21 | 0.056 | <0.003 | 0.006 | 0.20 | <0.002 | 0.005 | 0.41 | 0.031 | <0.01 |
| | A7 | 0.12 | 1.56 | 0.88 | 8.77 | 0.96 | 0.028 | 0.20 | 0.036 | 0.003 | 0.006 | 0.25 | <0.002 | 0.007 | 0.41 | 0.053 | <0.01 |
| Comparative | B1 | 0.08 | 0.18 | 1.06 | 9.29 | 0.91 | 0.036 | 0.17 | 0.020 | 0.006 | 0.004 | 0.77 | 0.004 | 0.004 | <0.01 | <0.005 | 0.04 |
| Example | B2 | 0.11 | 0.24 | 0.69 | 8.91 | 0.94 | 0.054 | 0.23 | 0.042 | 0.004 | 0.004 | 0.53 | 0.003 | 0.003 | <0.01 | <0.005 | 0.02 |
| | B3 | 0.11 | 0.25 | 0.70 | 8.51 | 1.01 | 0.058 | 0.19 | 0.041 | <0.003 | 0.006 | 0.16 | 0.002 | 0.004 | 0.42 | <0.005 | 0.01 |
| | B4 | 0.14 | 0.63 | 0.81 | 8.90 | 1.00 | 0.033 | 0.20 | 0.032 | 0.003 | 0.005 | 0.13 | 0.003 | 0.003 | 0.40 | <0.005 | 0.01 |
| | B5 | 0.14 | 0.46 | 0.78 | 8.98 | 1.01 | 0.032 | 0.20 | 0.034 | 0.003 | 0.005 | 0.12 | 0.027 | 0.002 | 0.40 | <0.005 | 0.01 |
| | B6 | 0.14 | 0.62 | 0.79 | 8.97 | 1.01 | 0.026 | 0.20 | 0.033 | 0.003 | 0.005 | 0.13 | 0.028 | 0.005 | 0.40 | <0.005 | 0.01 |
| | B7 | 0.14 | 0.45 | 0.77 | 8.86 | 1.01 | 0.026 | 0.20 | 0.035 | 0.003 | 0.005 | 0.13 | 0.042 | 0.006 | 0.40 | <0.005 | 0.01 |
| | B8 | 0.10 | 1.79 | 0.68 | 8.76 | 0.96 | 0.023 | 0.21 | 0.050 | <0.003 | 0.006 | 0.19 | <0.002 | 0.003 | 0.41 | <0.005 | <0.01 |
| | B9 | 0.09 | 2.00 | 0.64 | 9.15 | 0.97 | 0.033 | 0.26 | 0.046 | <0.003 | 0.006 | 0.17 | <0.002 | 0.011 | 0.35 | 0.034 | <0.01 |
| | B10 | 0.10 | 2.49 | 0.83 | 9.08 | 0.97 | 0.038 | 0.26 | 0.045 | <0.003 | 0.006 | 0.17 | <0.002 | 0.012 | 0.36 | 0.027 | <0.01 |

TABLE 2

| | | Measurement results | | | | | | |
|---|---|---|---|---|---|---|---|---|
| | | Back bead | | | | Weld metal | | |
| | | | | | Shape of | Ac1 | δ- | |
| | | | Back | Depres- | boundary | transfor- | Ferrite | Tensile |
| | | | bead | sion | between base | mation | area | strength |
| | | Back bead | height | depth | metal and | point | ratio | TS |
| No. | | appearance | (mm) | (mm) | back bead | (′G) | (%) | (MPa) |
| Inventive | A1 | Good | 1.0 | 0.3 | Good | 787 | <1.0 | 822 |
| Example | A2 | Good | 1.9 | 0.1 | Good | 832 | 3.1 | 812 |
| | A3 | Good | 0.7 | 0.1 | Good | 838 | 8.2 | 814 |
| | A4 | Good | 3.1 | 0.1 | Good | 818 | 2.1 | 805 |
| | A5 | Good | 1.7 | 0.1 | Good | 835 | 2.2 | 837 |
| | A6 | Good | 1.1 | 0.2 | Good | 838 | 8.5 | 843 |
| | A7 | Good | 2.7 | 0.0 | Good | 839 | <1.0 | 856 |
| Comparative | B1 | Back bead | 4.0 | 0.8 | Bad | 765 | — | 739 |
| Example | | oxidation/burn- | | | | | | |
| | | through | | | | | | |
| | B2 | Back bead | 4.1 | 1.1 | Bad | 795 | — | 809 |
| | | oxidation/burn- | | | | | | |
| | | through | | | | | | |
| | B3 | Back bead | 4.8 | 1.3 | Bad | 820 | — | 756 |
| | | oxidation/burn- | | | | | | |
| | | through | | | | | | |
| | B4 | Burn-through | 3.3 | 0.2 | Bad | — | — | — |
| | B5 | Back bead | 2.6 | 0.3 | Bad | — | — | — |
| | | oxidation/burn- | | | | | | |
| | | through | | | | | | |
| | B6 | Back bead | 2.6 | 0.3 | Bad | — | — | — |
| | | oxidation/burn- | | | | | | |
| | | through | | | | | | |
| | B7 | Back bead | 3.2 | 0.2 | Bad | — | — | — |
| | | oxidation/burn- | | | | | | |
| | | through | | | | | | |
| | B8 | Good | 0.5 | 0.4 | Good | 849 | 23.7 | 813 |
| | B9 | Good | 2.1 | 0.2 | Good | 864 | 26.6 | 830 |
| | B10 | Good | 1.5 | 0.3 | Good | >900 | 40.5 | 845 |

| | | Measurement results | | | | | | |
|---|---|---|---|---|---|---|---|---|
| | | Weld metal | | Evaluation results | | | | |
| | | Measurement | | | Weld metal | | | |
| | | temperature | Charpy | Back | Ac1 | δ- | | |
| | | (°C) of | impact | bead | transfor- | Ferrite | | |
| | | Charpy | value | Back | mation | area | Tensile | Tough- |
| No. | | impact test | (J/cm²) | bead | point | ratio | strength | ness |
| Inventive | A1 | 20 | 211 | A | B | A | A | A |
| Example | A2 | 20 | 80 | A | A | A | A | A |
| | A3 | 20 | 48 | A | A | B | A | B |
| | A4 | 20 | 63 | A | A | A | A | A |
| | A5 | 20 | 71 | A | A | A | A | A |
| | A6 | 20 | 129 | A | A | B | A | A |
| | A7 | 20 | 51 | A | A | A | A | B |
| Comparative | B1 | 20 | 321 | C | C | — | A | A |
| Example | B2 | 20 | 278 | C | B | — | A | A |
| | B3 | 20 | 191 | C | A | — | A | A |
| | B4 | — | — | C | — | — | — | — |
| | B5 | — | — | C | — | — | — | — |
| | B6 | — | — | C | — | — | — | — |
| | B7 | — | — | C | — | — | — | — |
| | B8 | 20 | 45 | A | A | C | A | B |
| | B9 | 20 | 28 | A | A | C | A | C |
| | B10 | 20 | 21 | A | A | C | A | C |

### [Evaluation Results]

As shown in Tables 1 and 2 above, although Inventive Example Nos. A1 to A7 are examples in which steel plates having a high content of Cr, which is generally difficult to form a good back bead, were welded together, the chemical components of the solid wire used were within the numerical range specified in the present invention. Therefore, it is possible to obtain back beads with excellent appearance and a weld metal with excellent mechanical performance without using a backing gas. In welding steel plates with a content of Cr of 8 mass % to 10 mass %, the poor appearance of the back beads is caused by the high content of Cr of the steel plates and welding materials, and therefore, the solid wire of the present embodiment can also be applied to a case where the content of Cr of the steel material to be welded is 1 mass % or more and less than 8 mass %. In other words, when the content of Cr of the steel material to be welded is 1 mass % or more and 10 mass % or less, by using the solid wire according to the present invention, a good weld metal can be obtained without using a backing gas.

On the other hand, in Comparative Example Nos. B1 to B7, the content of Si in the solid wire was less than the lower limit value specified in the present invention, and furthermore, in Comparative Example Nos. B5 to B7, the content of Ti in the solid wire exceeded the upper limit value specified in the present invention. Therefore, the evaluation results for back beads were bad. In Comparative Example No. B8, the content of Si in the solid wire exceeded the upper limit value specified in the present invention, and therefore the area ratio of δ-ferrite increased. Furthermore, in Comparative Example Nos. B9 and B10, the content of Si in the solid wire exceeded the upper limit value specified in the present invention, and therefore the area ratio of δ-ferrite increased and the evaluation results for toughness were bad.

Although various embodiments are described above, it is needless to say that the present invention is not limited to these embodiments. It is apparent that those skilled in the art can conceive of various modifications and alterations within the scope described in the claims, and it is understood that such modifications and alterations naturally fall within the technical scope of the present invention. In addition, the respective constituent elements in the above-described embodiments may be freely combined without departing from the gist of the invention.

The present application is based on Japanese Patent Application No. 2022-176386 filed on Nov. 2, 2022, the contents of which are incorporated herein by reference.

1. A solid wire
comprising, based on a total mass of the solid wire:
C: 0.05 mass % or more and 0.15 mass % or less;
Si: 0.8 mass % or more and 1.7 mass % or less;
Mn: 0.4 mass % or more and 1.2 mass % or less;
Cr: 7.5 mass % or more and 13.0 mass % or less;
Mo: 0.70 mass % or more and 1.5 mass % or less;
Nb: 0.010 mass % or more and 0.10 mass % or less;
V: 0.10 mass % or more and 0.50 mass % or less;
N: 0.010 mass % or more and 0.070 mass % or less;
P: 0.030 mass % or less;
S: 0.030 mass % or less;
Ni: 0.80 mass % or less;
Ti: 0.025 mass % or less;
A1: 0.020 mass % or less;
Co: 0.70 mass % or less; and
Fe.

2. The solid wire according to claim 1, further comprising, based on the total mass of the solid wire:
Zr: 0.10 mass % or less.

3. The solid wire according to claim 1, further comprising, based on the total mass of the solid wire:
Cu: 0.50 mass % or less.

4. A gas shielded arc welding method, comprising:
welding a steel material comprising 1 mass % or more and 10 mass % or less of Cr, with the solid wire according to claim 1, without using a backing gas.

5. A gas shielded arc welding method comprising:
welding a steel material comprising 1 mass % or more and 10 mass % or less of Cr, with the solid wire according to claim 3, without using a backing gas.

6. The solid wire according to claim 2, further comprising, based on the total mass of the solid wire:
Cu: 0.50 mass % or less.

7. A gas shielded arc welding method, comprising:
welding a steel material comprising 1 mass % or more and 10 mass % or less of Cr, with the solid wire according to claim 2, without using a backing gas.
